(19) United States
(12) Patent Application Publication
(10) Pub. No.: US 2009/0243560 A1
(43) Pub. Date: Oct. 1, 2009

(54) Pulse-position-modulated vehicular alternator voltage regulator with dual AC-feedback networks, controlled "OFF" period and low inserted electrical noise

(76) Inventors: Luis E. Bartol, Mexico (MX); Muriel L. Bartol, Los Angeles, CA (US)

Correspondence Address: William C. Fuess;Attorney at Law, Suite 2G, 10951 Sorrento Valley Road, San Diego, CA, 92121-1613, US

(21) Appl. No.: 12/079,273

(22) Filed: Mar. 25, 2008

(51) Int. Cl. H02P 9/48

(52) U.S. Cl. 322/28

(57) ABSTRACT

A Frequency-On-Demand type voltage regulator firstly has its power output circuit configured as a resettable monostable multivibrator that provides (1) a stable time-base that serves as an internal “OFF”-period reference; preferably also with (2) short-circuit protection to the output power transistor; and (3) a pulse train with sharply defined “ON” and “OFF” transitions as the result of the interaction between the Output and Input Stages of the Power Output Circuit through a first AC Feedback Network. The “ON” and “OFF” transitions are preferably rounded-off. Secondly, yet another, second, AC feedback network is added between the Output Stage of the Power Output Circuit and the Error-Detector/Voltage Divider Stage of the Frequency-On-Demand type voltage regulator. This second feedback network provides (1) a controlled “OFF”-period synchronized with the Output Stage signal; (2) protection against loss of a reference voltage; (3) a dead band” associated with the “ON” and “OFF” periods that confers exceptional tolerance to system electrical noise; and (4) a voltage compensation feature with “flat”, “drooping” or “rising” system voltage output characteristic versus system loading.

### REFERENCE TO RELATED PATENTS

The present patent application is related to U.S. Pat. No. 6,667,739 issued Jan. 13, 2004 for a HIGH-RELIABILITY, LOW-COST, PULSE-WIDTH-MODULATED VEHICULAR ALTERNATOR VOLTAGE REGULATOR WITH SHORT-CIRCUIT PROTECTION AND LOW INSERTED ELECTRICAL NOISE to Luis E. Bartol and Muriel Bartol, which said Luis E. Bartol and Muriel Bartol are co-inventors of the present invention.

This related predecessor patent, and the present application, are in turn related to U.S. Pat. No. 5,744,941 issued Apr. 28, 1998, for a SINGLE-WIRE-CONNECTED HIGH-SENSITIVITY DUAL MODE A.C./D.C. TURN-ON/TURN-OFF STAGE FOR AN ELECTRONIC VOLTAGE REGULATOR issued to Luis E. Bartol and German Holguin, and to U.S. Pat. No. 5,325,044 issued Jun. 28, 1994 for an ELECTRONIC VOLTAGE REGULATOR PROTECTED AGAINST FAILURE DUE TO OVERLOAD, OR DUE TO LOSS OF A REFERENCE VOLTAGE to Luis E. Bartol.

The contents of the related predecessor patents are incorporated herein by reference.

### BACKGROUND OF THE INVENTION

1. Field of the Invention

The present invention generally concerns improvements to voltage regulators in general, and in particular concerns improvements to vehicular electronic voltage regulators used in heavy duty, high current, high performance applications. Because the main design intent of the present invention is concerned with high reliability in heavy duty applications, the improvements of the present invention are particularly useful for (i) revenue-generating vehicles such as trucks and buses, and (ii) emergency vehicles such as ambulances and fire trucks.

2. Description of Prior Art

Two basic design technologies have dominated the electronic voltage regulator art: 1) Frequency-On-Demand and 2) Pulse-Width-Modulation.

2.1 Frequency-On-Demand Type Voltage Regulators

Frequency-On-Demand is by far the oldest and most widely used design for voltage regulators including vehicular alternator voltage regulators. The Frequency-On-Demand design provides adequate performance in most automotive and light duty applications. It works on the principle that an error signal is generated by comparing the vehicle's electrical system voltage to an internal reference, then further amplified and used to drive the regulator's output stage. The output stage in turn controls the current through the alternator's field.

The interaction between the output and input stages of the power circuit (normally through an RC network), produces a sharply-defined rectangular pulse-train whose duty cycle determines the excitation level in the field and hence, the current generating capacity of the vehicle's alternator, for a given rotational speed.

As alternators became larger because of higher use of electrical power in vehicles, the response time due to very large field inductances and currents involved became quite significant and when added to the response time of the voltage regulator itself, resulted in a noticeable (and objectionable) voltage/current low frequency fluctuation at the alternator output. This phenomena is most noticeable both at no-load and near full load conditions. In an attempt to deal with this problem, the modern Frequency-On-Demand type voltage regulator is designed with a faster response time. The downside of this improvement is that the ON-OFF-ON transitions of the pulse-train had to be made faster, which increased the level of electrical noise introduced into the vehicle's electrical system.

With the present massive use (circa 2008) of computers in vehicles, the demand for electrically clean, stable voltage in the vehicle's electrical system becomes another driving factor forcing improvements over the traditional Frequency-On-Demand technology.

2.2 Pulse Width Modulation Type Voltage Regulators

The Pulse Width Modulation technology consists of internally generating a constant-frequency pulse-train and modulating the duty cycle to vary the excitation level in the field. Since the field-driving pulse-train has a constant frequency that does not depend on external variables such as the field inductance and current flowing into the field, this technology eliminates the low frequency fluctuations of the Frequency-On-Demand systems. Also, rise and fall times of the ON-OFF-ON transitions can be made sufficiently slow to insert an acceptable level of electrical noise into the vehicle's electrical system.

Up until recently, cost and complexity issues kept this technology available only in those applications that demanded high levels of performance. On Jan. 13, 2004, the inventors of the present patent application were granted U.S. Pat. No. 6,667,739 that teaches a low cost, high reliability, high performance Pulse-Width-Modulated voltage regulator. The economical design of this patent made pulse width modulation technology available to a much wider range of applications.

Pulse-Width-Modulation is a flexible and powerful technology. However, it is not without limitations. Its very reliance on a fixed frequency makes it particularly vulnerable to high electrical noise environments such as electrical vehicular systems that have temporarily lost battery connections, typically as a result of such connections becoming loose in the high-vibration environment of the modern heavy duty vehicle.

Also, there are vehicular power applications where the battery is dispensed with altogether, typically in multiple electrical generating systems where one of the alternators drives a specific load, such as an air conditioning system and for reliability and other reasons, is operated separate from the vehicle's main electrical generating system and designed to run without a battery. In this case, when a large electrical load is applied to the battery-less alternator, it could cause the permanent shut-off of the voltage regulator, rendering inoperable the auxiliary battery-less system.

The Frequency-On-Demand voltage regulator technology is much less affected by a battery-less condition and is the design of choice for this application.

It is clear from the above discussion that an improved Frequency-On-Demand regulator, able to operate from an internal reference signal and to be thus immune to the effects of large field inductances and other external variables, and furthermore modified to introduce an acceptable level of electrical noise into the electrical generating system, would become a “Universal” device, able to perform reliably under the most extreme operating conditions.

### SUMMARY OF THE INVENTION

The present invention, which has been fully and thoroughly tested by its inventors, targeted the use of proven, high reliability Frequency-On-Demand voltage regulators such as those taught in U.S. Pat. Nos. 5,325,044 and 5,744,941 with the intention of eliminating certain unresolved issues associated with these designs, namely (1) voltage/current fluctuations both at no-load and near full-load (known in the trade as “jitter”), and (2) abrupt transitions in the ON-OFF-ON cycles as induce system noise. The modifications used to accomplish these objectives are as follows:

First, a power stage of a Frequency-On-Demand type voltage regulator is configured as a resettable monostable multivibrator that provides: (1) a stable time-base that serves as an internal “OFF”-period reference, (2) short-circuit protection to the output power transistor as taught in U.S. Pat. Nos. 5,325,044 and 5,744,941; and (3) a pulse train with sharply defined “ON” and “OFF” transitions as the result of the interaction between the Output and Input Sections of the power stage through a first AC Feedback Network; and (4) voltage-reference loss protection. Additionally, the “ON” and “OFF” regulating signal transitions are rounded-off as is taught in U.S. Pat. No. 6,667,739 to reduce inserted electrical noise.

Second, another, second, AC feedback network is added between the Output Stage and the Error-Detector/Voltage Divider Stage of the Frequency-On-Demand type voltage regulator. This second feedback network provides (1) a controlled “OFF”-period synchronized with the Output Stage signal; (2) a “dead band” associated with the “ON” and “OFF” periods that confers exceptional tolerance to system electrical noise; and (3) a voltage compensation feature with “flat”, “drooping” or “rising” system voltage output characteristic versus system loading.

Of the first and the second elements above, the second AC feedback network constitutes the key element in rendering a Frequency-On-Demand voltage regulator that complies with the objects of the present invention. Moreover, this new, second, feedback network produces an added bonus: it also enables an exceptionally tight voltage regulation. The benefits accrued by the incorporation of the second AC feedback enhance the performance of those prior art voltage regulators referenced as FIGS. 1 and 2 (as respectively show voltage regulators in accordance with U.S. Pat. Nos. 5,325,044 and 5,744,941), without interfering with, or decreasing the efficacy of, any of the valuable features incorporated in these prior art regulators. For example, the short-circuit protection feature of the previous voltage regulators remains intact in the new proposed designs of the present invention. Also, the voltage-reference loss feature of the previous regulators is now fully implemented by the second AC feedback network, which serves to trigger a safe self-oscillating mode upon loss of the reference voltage (“B+” in FIG. 3 and “NEG” in FIG. 4).

The modifications in accordance with the present invention that are required to so improve performance—namely, the second feedback network—do not significantly affect the cost, reliability and/or complexity of the current Frequency-On-Demand voltage regulators.

1. A (Second) Feedback Network Improvement to a Frequency-On-Demand Type Alternator Voltage Regulator

Thus in one of its aspects the present invention is embodied in an improvement to a Frequency On-Demand type alternator voltage regulator having (1) an error-detector/voltage-divider error amplifier stage responsive to a voltage-divided alternator output signal to produce an error signal, (2) a resettable monostable multivibrator power output stage responsive to the received error signal to produce a rectangular pulse-train a duty cycle of which pulse-train controls the excitation of a field winding of an alternator, and thus the current generation of the alternator for a given rotational speed, and (3) a first AC feedback path between (1) the output and (2) input stages of the power output circuit. In this regulator the present invention is an improvement including a second feedback network between (1) the output stage of the power output circuit and (2) the voltage-divided alternator output signal. By this feedback a “dead band” associated with “ON” and “OFF” periods of excitation of the alternator field winding is created, confering tolerance to system electrical noise.

The improvement to the Frequency-On-Demand type voltage regulator preferably further realizes a stable internal time reference of the resettable monostable multivibrator output stage. This reference serves to maintain “OFF” the output stage for a fixed time interval, and current through a field winding of an alternator connected to the output stage. By this structure, and this operation, voltage/current fluctuations both at no load and at near full load on the alternator, said fluctuations known in the trade as “jitter”, are substantially eliminated.

The new, second feedback network, improvement to the Frequency-On-Demand type voltage regulator preferably includes (1) a resistor, in electrical series with (2) a capacitor.

2. A Frequency-On-Demand Type Voltage Regulator

In another of its aspects the present invention may simply be considered to be embodied in a Frequency-On-Demand type voltage regulator including (1) an error-detector/voltage divider stage, (2) a resettable monostable multivibrator output stage having a stable time-base that serves as an internal “OFF”-period reference, (3) a first AC feedback network between the output of the resettable monostable multivibrator output power stage and the input to this stage, and (4) a second AC feedback network between the output of the resettable monostable multivibrator output stage and the input to the error-detector/voltage-divider stage providing a controlled “OFF”-period synchronized with the Output Stage signal.

In this Frequency-On-Demand type voltage regulator the resettable monostable multivibrator output stage preferably includes short circuit protection to a power output transistor.

In this Frequency-On-Demand type voltage regulator the resettable monostable multivibrator output stage preferably still further has a pulse train with sharply defined “ON” and “OFF” transitions as the result of the interaction between the Output and Input sections of the Power Output Circuit through a First AC Feedback Network.

In this Frequency-On-Demand type voltage regulator the second AC feedback network preferably induces a “dead band” associated with the “ON” and “OFF” periods that confers tolerance to system electrical noise.

In this Frequency-On-Demand type voltage regulator the second AC feedback network preferably still further has a voltage compensation feature with “flat”, “drooping” or “rising” system voltage output characteristic versus system loading.

3. A Method of Controlling a Frequency-On-Demand Type Voltage Regulator

In yet another of its aspects the present invention is embodied in a method of controlling a Frequency-On-Demand type voltage regulator. The method includes (1) configuring a power output circuit of the voltage regulator as a resettable monostable multivibrator with a stable internal time base so as to produce an “OFF” signal for a constant period, and (2) placing an additional, second, AC feedback network between the output stage and an earlier error-detector/voltage divider stage to provide a controlled “OFF” signal synchronized with the “OFF” signal of the output stage.

### BRIEF DESCRIPTION OF THE DRAWINGS

FIGS. 1 and 2 show schematic diagrams of Prior Art voltage regulators built according to the principles taught in respective U.S. Pat. No. 5,325,044 and 5,744,941.

FIG. 3 is a schematic diagram of a preferred, first, embodiment of the “core” electronic voltage regulator of the present invention.

FIG. 4 is a schematic diagram of another, second, preferred embodiment of the “core” electronic voltage regulator of the present invention.

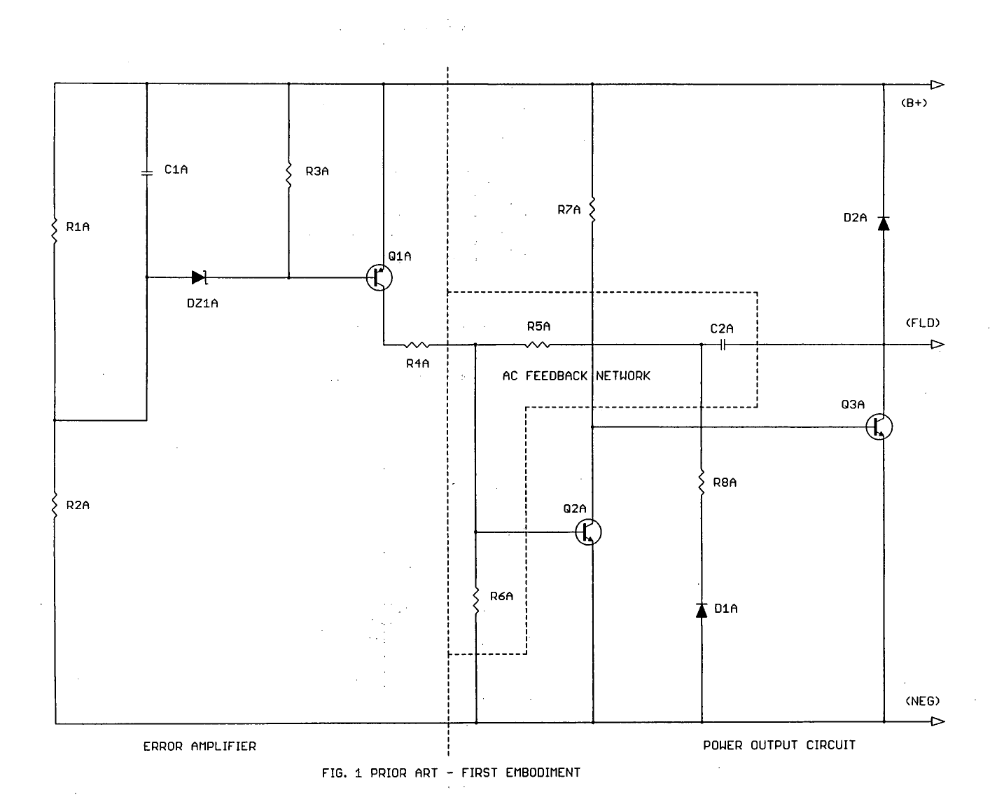

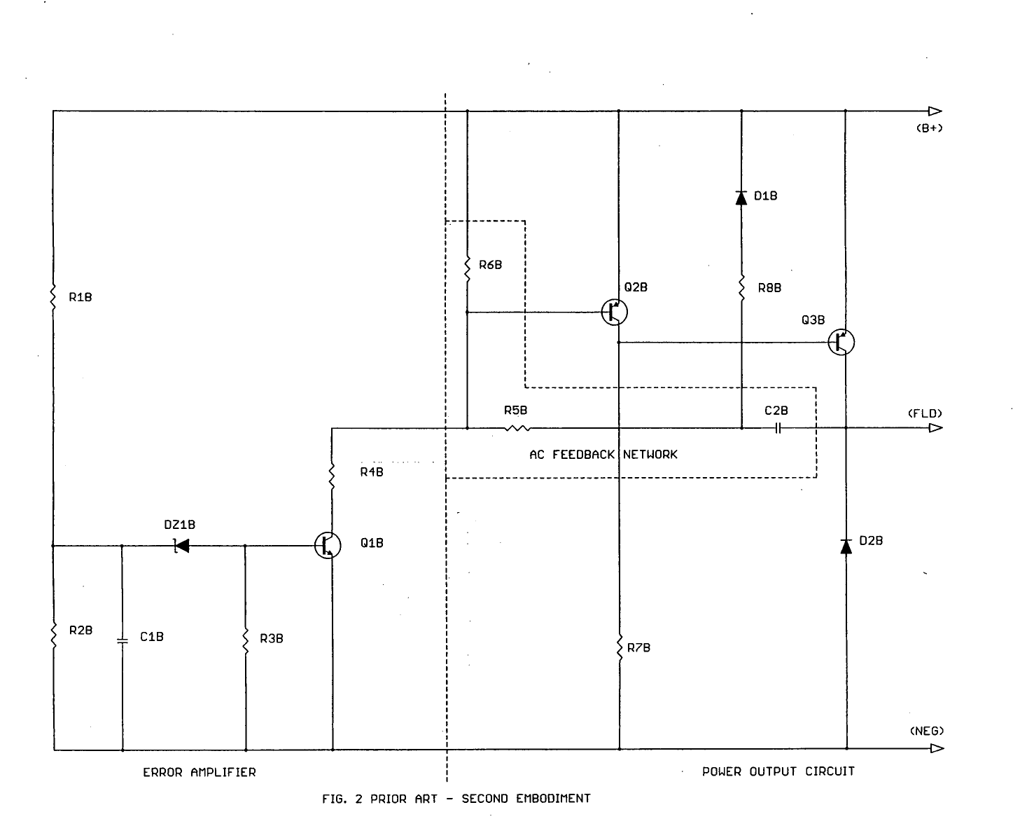

### DESCRIPTION OF THE PREFERRED EMBODIMENT

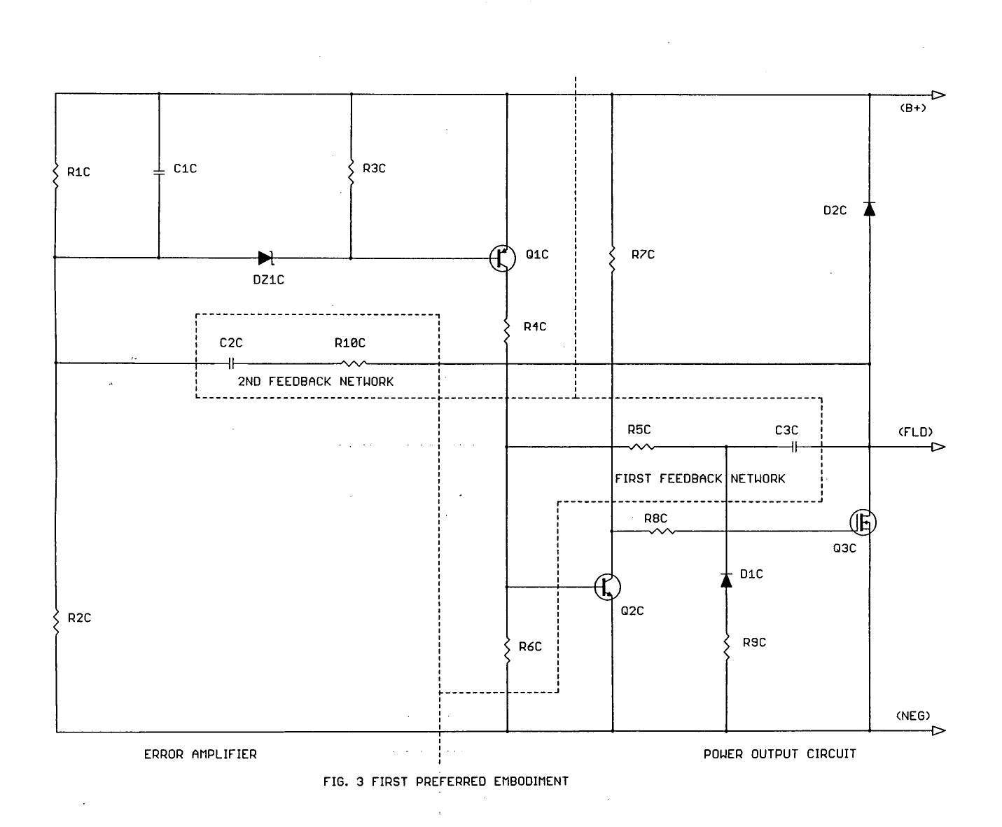

1. A functional description of a preferred first, proposed “A-type” (one end of the alternator field connected to “B+”) embodiment of the present invention referenced to the schematic drawing of FIG. 3 is as follows:

1.1 The network comprised by Q2C, R5C, R6C, R7C, R8C, R9C, D1C, D2C, C3C and Q3C is functionally a resettable, monostable multivibrator whose time constant is primarily determined by R5C, R6C and C3C. Diode D1C and resistor R9C reset capacitor C3C to a residual, well-defined reset voltage, every time power transistor Q3C goes into conduction. As taught in U.S. Pat. Nos. 5,325,044 and 5,744,941, diode D1C is the key element of the short-circuit protection function, Therefore, this short-circuit protection scheme doubles as a resettable, monostable multivibrator timer. The utilization of this built-in timer as an internal reference to make the response time of the voltage regulator independent of external variables is one of the objects of the present invention.

1.2 Considering steady state conditions with the vehicle's alternator rotating, voltage detection network C1C, R1C, R2C, R3C and DZ1C, develops a voltage across the base-emitter resistor R3C of error-amplifier transistor QIC, that is related to the difference between the vehicle's system voltage (across terminals “B+” and “NEG”) and the reference voltage of Zener DZ1C plus Emitter-Base voltage of transistor QIC. When system voltage exceeds the reference voltage, transistor QIC goes into conduction which in turn makes transistor Q2C also go into conduction thus shutting off power transistor Q3C. When Q2C goes into conduction, it rapidly triggers the resettable monostable multivibrator that latches an “OFF” output period for the duration of the time constant of said monostable. During the “OFF” period, the monostable cannot be reset by external noise, thus the monostable time constant acts as a filter to spurious reset signals.

1.3 When Q3C shuts off, it connects the Second Feedback Network in parallel with voltage divider resistor R1C through the “FLD” (field) connection. The resulting parallel combination has a smaller instantaneous impedance than R1C, therefore, the regulator voltage divider targets a higher cutoff voltage.

Conversely, when system voltage drops below the reference voltage, transistor Q3C will be driven into conduction by the error amplifier which cuts-off transistors Q1C and Q2C. When Q3C is conducting, it connects in parallel the Second Feedback Network with voltage divider resistor R2C resulting in a smaller instantaneous impedance than R2C, thus the voltage divider now targets a lower target voltage.

Thus, the effect of the Second Feedback Network is the creation of a “dead band” in the turn-on and cut-off points which result in a remarkable tolerance to system noise and a very predictable “OFF” period—or putting it in another way—a controlled “OFF” period followed by a variable “ON” period (to accommodate for changing load conditions in the generating system). The “OFF” period is dependent only on internal parametric values and thus minimally dependent on external electrical parameters such as field inductance, field current and system loading. Additionally, the Second Feedback Network injects into the voltage divider network high voltage pulses appearing in the Field terminal—such as when the voltage reference is lost—and results in a safe oscillation while the voltage reference remains disconnected.

1.4 Additionally, the Second Feedback Network has another beneficial effect regarding system regulation; with the proper choice of values for C2C and R10C, the system voltage can be made: (i) constant, (ii) slightly drooping or (iii) slightly rising, with regard to electrical loads over the complete range of alternator speeds. This is a result of feeding back to the voltage divider capacitor C1C the alternator's field waveform—through C2C and R10C—and algebraically adding the instantaneous voltage across capacitor C1C to the instantaneous voltage across C2C, which charges and discharges when Q3C turns “ON” and “OFF” respectively. The ratio of the “ON” period to the total period (“ON”+“OFF”) is called the Duty Cycle and represents the percentage of time the output transistor Q3 is “ON” and is therefore also a measure of the current flowing through the field. For a constant voltage system, a large field current means that a correspondingly large current is being supplied to the electrical loads by the generating system. Under these circumstances, the “ON” period will be longer with respect to the “OFF” period, and capacitor C2C will charge to a higher voltage. Since the instantaneous polarity of the voltage across C2C—at the end of the “ON” period—subtracts from the voltage across capacitor C1C, the net voltage across C1C will be smaller as the field duty cycle increases, thereby stretching the time it takes to charge C1C to its cut-off value and increasing even more the duration of the “ON” period. This phenomena allows compensating for the natural “voltage slump” characteristic—when system loading is increased—simply by the judicious selection of the parametric values of C2C and R10C.A “flat”, “drooping” or “rising” voltage-versus-load characteristic can be easily selected in this manner.

1.5 As a first approximation, it can be said that for the modified regulators of the present invention, a “constant” “OFF” period is followed by a variable “ON” period—with the frequency being maximum at or near no-load conditions—when the “ON” period is at a minimum.

The preceding discussion is somehow a simplified version of real life conditions since when system load increases, system noise is also increased and a “ripple” waveform appears on the alternator's output terminals. A bigger load signifies higher ripple and since ripple is the alternating current component of the alternator output waveform, whatever increases ripple such as load, rotational speed, a faulty battery, etc., will have a bearing on the “OFF” cycle since the capacitive component of the First Feedback Network will present a smaller impedance to higher ripple or ripple of a higher frequency.

The reactance of capacitor C3C used in the First Feedback Network decreases in the presence of ripple, therefore the monostable multivibrator's “OFF” period tends to become smaller as the ripple content (and/or its frequency) becomes larger. However, for a given set of alternator conditions such as speed (RPM), load and field current, it can be stated that the “OFF” period has a small variation as compared with the “ON” period and therefore in this context it can be considered approximately constant.

A pulse train with a constant “OFF” period followed by a variable “ON” period constitutes what is commonly called a “PULSE POSITION MODULATION” system in Electronic Communications theory and the inventors feel that this name reasonably describes the workings of the present invention.

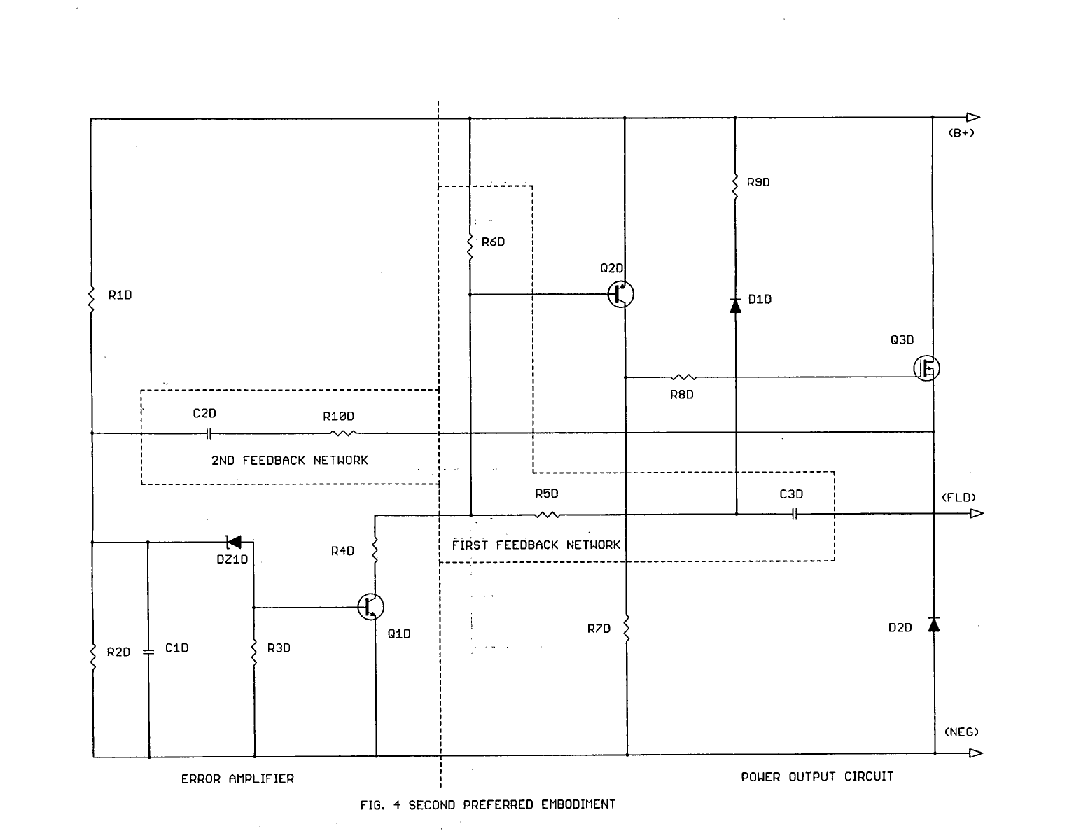

2. In the preceding discussion, only an “A-type” embodiment of the present invention was described incorporating an N-Channel Metal Oxide Semiconductor (MOS) power transistor. A second preferred embodiment of the present invention is shown in FIG. 4 as a “B-type” (one end of the alternator field connected to “NEG”) incorporating a P-Channel MOS power transistor. The functional description of this second, preferred embodiment is identical to the one used for the first preferred embodiment.

In accordance with the preceding explanations and the two embodiments within which the present invention has been shown, the invention should be interpreted broadly, in accordance with the following claims, only, and not solely in accordance with those embodiments within which the invention has been taught.

What is claimed is:

1. In a Frequency-On-Demand type alternator voltage regulator having
an error-detector/voltage-divider error amplifier stage responsive to a voltage-divided alternator output signal to produce an error signal,
a resettable monostable multivibrator power output stage responsive to the received error signal to produce a rectangular pulse-train a duty cycle of which pulse-train controls the excitation of a field winding of an alternator, and thus the current generation of the alternator for a given rotational speed, and
a first AC feedback path between (1) the output and (2) input stages of the power output circuit, the improvement comprising:
a second feedback network between (1) the output stage of the power output circuit and (2) the voltage-divided alternator output signal;
wherein a “dead band” associated with “ON” and “OFF” periods of excitation of the alternator field winding confers tolerance to system electrical noise;

2. The Frequency-On-Demand type voltage regulator according to claim 1 wherein the improvement further comprises:
a stable internal time reference of the resettable monostable multivibrator output stage which reference serves to maintain “OFF” the output stage for a fixed time interval, and current through a field winding of an alternator connected to the output stage;
wherein voltage/current fluctuations both at no load and at near full load on the alternator, said fluctuations known in the trade as “jitter”, are substantially eliminated.

3. The improvement to a Frequency-On-Demand type voltage regulator according to claim 1 wherein the second feedback network comprises:
a resistor; in electrical series with a capacitor.

4. A Frequency-On-Demand type voltage regulator comprising:
an error-detector/voltage divider stage;
a resettable monostable multivibrator output stage having (1) a stable time-base that serves as an internal “OFF”-period reference;
a first AC feedback network between the output of the resettable monostable multivibrator output power stage and the input to this stage; and
a second AC feedback network between the output of the resettable monostable multivibrator output stage and the input to the error-detector/voltage-divider stage providing (1) a controlled “OFF”-period synchronized with the Output Stage signal.

5. The Frequency-On-Demand type voltage regulator according to claim 4 wherein the resettable monostable multivibrator output stage further has
(2) short circuit protection to a power output transistor.

6. The Frequency-On-Demand type voltage regulator according to claim 5 wherein the resettable monostable multivibrator output stage further has (3) a pulse train with sharply defined “ON” and “OFF” transitions as the result of the interaction between the Output and Input sections of the Power Output Circuit through a First AC Feedback Network.

7. The Frequency-On-Demand type voltage regulator according to claim 4 wherein the second AC feedback network further provides
(5) a “dead band” associated with the “ON” and “OFF” periods that confers tolerance to system electrical noise.

8. The Frequency-On-Demand type voltage regulator according to claim 7 wherein the second AC feedback network further provides (6) reference-loss protection in case the voltage reference is momentarily lost.

9. The Frequency-On-Demand type voltage regulator according to claim 8 wherein the second AC feedback network further provides
(7) a voltage compensation feature with “flat”, “drooping” or “rising” system voltage output characteristic versus system loading.

10. A method of controlling a Frequency-On-Demand type voltage regulator comprising:
configuring a power output circuit of the voltage regulator as a resettable monostable multivibrator with a stable internal time base so as to produce an “OFF” signal for a constant period; and
placing an additional, second, AC feedback network between the output stage and an earlier error-detector/voltage divider stage to provide a controlled “OFF” signal synchronized with the “OFF” signal of the output stage.

11. The method of controlling a Frequency-On-Demand type voltage regulator according to claim 10 wherein the placing of the additional, second, AC feedback network does further provide protection against loss of a reference voltage.
